(19) United States
(12) Patent Application Publication
(10) Pub. No.: US 2022/0019062 A1
(43) Pub. Date: Jan. 20, 2022

(54) DOUBLE TELECENTRIC PROJECTION LENS AND PROJECTION SYSTEM

(71) Applicant: IVIEW DISPLAYS (SHENZHEN) COMPANY LTD., Shenzhen (CN)

(72) Inventors: Di Tan, Shenzhen (CN); Zhiqiang Gao, Shenzhen (CN); Steve Yeung, Shenzhen (CN); Yuan Zhao, Shenzhen (CN)

(21) Appl. No.: 17/490,687

(22) Filed: Sep. 30, 2021

Related U.S. Application Data
(63) Continuation of application No. PCT/CN2019/129570, filed on Dec. 28, 2019.

(30) Foreign Application Priority Data
Apr. 1, 2019 (CN) 201910258524.3

(51) Int. Cl. G02B 13/22; G02B 5/04; G02B 9/08

(52) U.S. Cl. CPC G02B 13/22; G02B 9/08; G02B 5/04

(57) ABSTRACT

Embodiments of the present disclosure relate to the technical field of projection, and provide a double telecentric projection lens and a projection system. The double telecentric projection lens includes a first lens group, an aperture stop, and a second lens group that are successively arranged from an object side to an image side, a center of the aperture stop being at a rear focus of the first lens group and a front focus of the second lens group; wherein a focal power of the double telecentric projection lens is greater than 0.03, an object-side numerical aperture of the double telecentric projection lens is 1.7, and an image-side numerical aperture of the double telecentric projection lens is 5.95.

### CROSS-REFERENCE TO RELATED APPLICATIONS

This application is a continuation of International Patent Application No. PCT/CN2019/129570, filed on Dec. 28, 2019, which is based upon and claims priority to Chinese Patent Application No. 2019102585243, filed before China National Intellectual Property Administration on Apr. 1, 2019 and entitled “DOUBLE TELECENTRIC PROJECTION LENS AND PROJECTION SYSTEM”, the entire contents of which are incorporated herein by reference.

### TECHNICAL FIELD

The present disclosure relates to the technical field of projection, and provides a double telecentric projection lens and a projection system.

### BACKGROUND

During the last decade, machine vision has gained rapid and constant development and improvement, and has become an indispensable part in the field of detection. Image lenses, as eyes of the machine vision, are particularly important.

A double telecentric projection lens refers to a projection lens including an object-side telecentric light path and an image-side telecentric light path. The principle of the double telecentric projection lens is as follows: An aperture stop is placed in an object-side focal plane and an image-side focal plane such that a primary light ray on the object side and a primary light ray on the image side are parallel to an optical axis, and these two telecentric light paths are combined to constitute a double telecentric imaging light path.

### SUMMARY

Accordingly, the embodiments of the present disclosure provide a double telecentric projection lens. The double telecentric projection lens includes a first lens group, an aperture stop, and a second lens group that are successively arranged from an object side to an image side, a center of the aperture stop being at a rear focus of the first lens group and a front focus of the second lens group; wherein the first lens group is configured to receive a projection light beam incident parallel to a central optical axis of the first lens group, and expand the projection light beam; the aperture stop is configured to receive the projection light beam emitted from the first lens group, and cause the projection light beam to be transmitted to the second lens group; and the second lens group is configured to receive the projection light beam emitted from the aperture stop, converge the projection light beam, and cause the projection light beam to be emitted parallel to a central optical axis of the second lens group; wherein a focal power of the double telecentric projection lens is greater than 0.03, an object-side numerical aperture of the double telecentric projection lens is 1.7, and an image-side numerical aperture of the double telecentric projection lens is 5.95.

Further, the embodiments of the present disclosure provide a projection system. The projection system includes the double telecentric projection lens as described above.

### BRIEF DESCRIPTION OF THE DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic structural diagram of a double telecentric projection lens according to an embodiment of the present disclosure;

FIG. 2 is a schematic structural diagram of a double telecentric projection lens according to an embodiment of the present disclosure;

FIG. 3a is a schematic diagram of a modulation transfer function of the double telecentric projection lens at a spatial frequency of 1001 p/mm in FIG. 1;

FIG. 3b is a schematic diagram of a modulation transfer function of the double telecentric projection lens at a spatial frequency of 1001 p/mm in FIG. 1 upon introduction of a tolerance;

FIG. 4 is a schematic diagram of a distortion curve of the double telecentric projection lens in FIG. 1;

FIG. 5 is a schematic diagram of a curve of a field curvature of the double telecentric projection lens in FIG. 1;

FIG. 6 is a schematic diagram of a curve of relative illumination of the double telecentric projection lens in FIG. 1; and

FIG. 7 is a schematic structural diagram of a projection system according to an embodiment of the present disclosure.

### DETAILED DESCRIPTION

For better understanding of the present disclosure, the present disclosure is described in detail with reference to attached drawings and specific embodiments. It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. In the description of the present disclosure, it should be understood that the terms “vertical,” “horizontal,” “left,” “right,” “up,” “down,” “inner”, “outer,” “bottom,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure. In addition, the terms “first,” “second,” and the like are merely for the illustration purpose, and shall not be construed as indicating or implying a relative importance.

Unless the context clearly requires otherwise, throughout the specification and the claims, technical and scientific terms used herein denote the meaning as commonly understood by a person skilled in the art. Additionally, the terms used in the specification of the present disclosure are merely for description the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

Single lenses or zoom lenses known to inventors are low in cost. However, such lenses have demerits of greater image distortions, and hence cause greater measurement errors. Telecentric lenses known to the inventors are mainly designed for correcting parallax of the traditional industrial lenses. Within a specific physical range, the telecentric lens ensures that a magnification of an acquired image does not change. Due to unique optical characteristics of high resolution, super-wide depth of field, super-low distortion, unique parallel light, and the like, the telecentric lens promotes precision detection of the machine vision to a higher level. The double telecentric projection lens known to the inventors is capable of further eliminating distortions on the object side and distortions on the image side, and hence further improving detection accuracy. During practice of the present application, the inventors have identified that the current double telecentric projection lens has a relatively complex structure.

A double telecentric projection lens according to the embodiments of the present disclosure has a simple structure, and achieves a good illumination uniformity.

The double telecentric projection lens according to the embodiments of the present disclosure is applicable to a projection system according to the embodiments, such that the projection system has a simple structure, and achieves a good illumination uniformity.

Specifically, hereinafter a double telecentric projection lens and a projection system are illustrated with reference to specific embodiments.

### First Embodiment

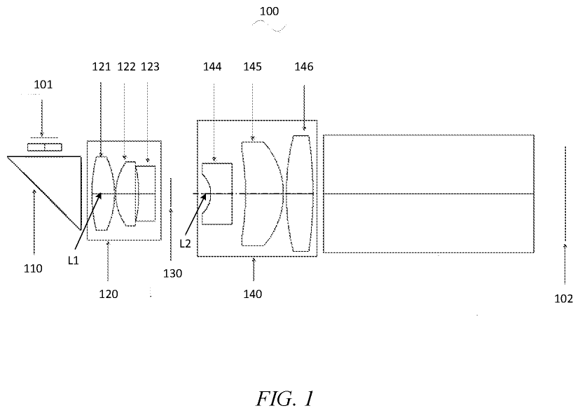

Referring to FIG. 1, FIG. 1 is a schematic structural view of a double telecentric projection lens according to an embodiment of the present disclosure. As illustrated in FIG. 1, the double telecentric projection lens 100 includes a redirecting mirror 110, a first lens group 120, an aperture stop 130, and a second lens group 140 that are successively arranged from an object side to an image side, wherein a center of the aperture stop 130 is at a rear focus of the first lens group 120 and a front focus of the second lens group 140.

The redirecting mirror 110 is configured to redirect a projection light beam such that the projection light beam is incident to the first lens group 120. The first lens group 120 is configured to receive a projection light beam incident parallel to a central optical axis L1 of the first lens group 120, and expand the projection light beam. The aperture stop 130 is configured to receive the projection light beam emitted from the first lens group 120, and cause the projection light beam to be transmitted to the second lens group 140. The second lens group 140 is configured to receive the projection light beam emitted from the aperture stop 130, converge the projection light beam, and cause the projection light beam to be emitted parallel to a central optical axis L2 of the second lens group 140. A focal power of the double telecentric projection lens 100 is greater than 0.03, an object-side numerical aperture of the double telecentric projection lens 100 is 1.7, and an image-side numerical aperture of the double telecentric projection lens 100 is 5.95. By placing the aperture stop to an image-side focal plane and an object-side focal plane, a primary light ray on the object side and a primary light ray on the image side are parallel to the optical axis, a double telecentric imaging light path is formed. In addition, the structure is simple, and illumination uniformity is good.

The redirecting mirror 110 may be a total internal reflection (TIR) prism, and is configured to reflect the light beam. The redirecting mirror 110 may be a right-angled triangular prism. The redirecting mirror 110 is arranged on one side, distal from the aperture stop 130, of the first lens group 120. In addition, one right-angled face (the right-angled face is a side formed by right-angled edges) of the redirecting mirror 110 is opposite to the object side, and the other right-angled face of the redirecting mirror 110 is opposite to the first lens group 120, and is perpendicular to the central optical axis L1 of the first lens group 120. A reflection angle of an inclined plane of the redirecting mirror 110 may be 90 degrees. The redirecting mirror 110 is configured to receive the projection light beam incident from one of the right-angled faces perpendicular to the redirecting mirror 110, and redirect the projection light beam, such that the projection light beam is incident to the first lens group 120 parallel to the central optical axis L1 of the first lens group 120, and the primary light ray on the object side is parallel to the optical axis.

Optionally, in some other embodiments, the redirecting mirror 110 may be not a triangular prism, or may be another prism or plane mirror, or the like. When the redirecting mirror 110 is another prism, the projection light beam may be incident to the redirecting mirror 110 at another angle, and the reflection angle of the redirecting mirror 110 may be at other degrees, as long as the projection light beam finally output by the redirecting mirror 110 is parallel to the central optical axis L1 of the first lens group 120.

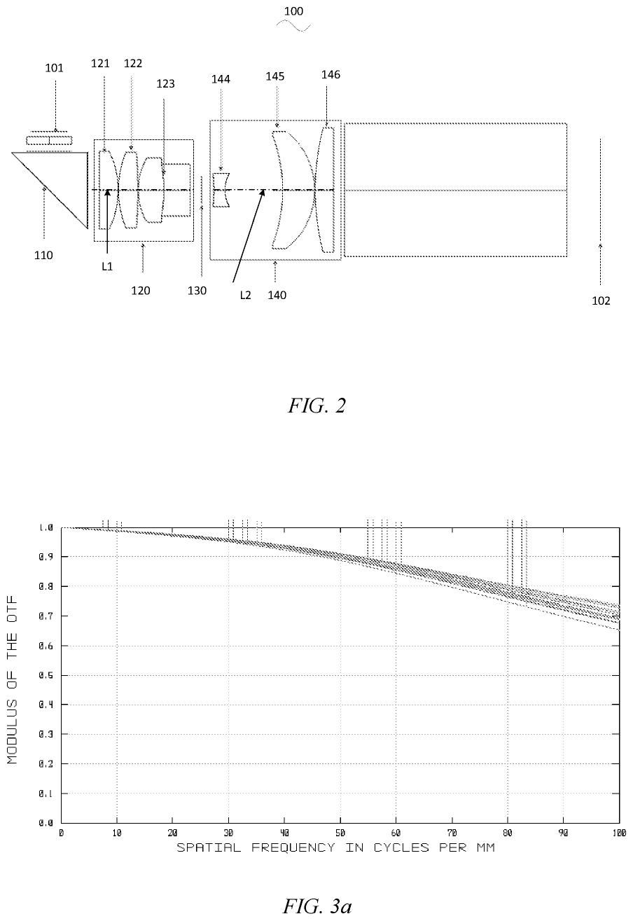

Optionally, as illustrated in FIG. 1 and FIG. 2, the double telecentric projection lens 100 may further include an object surface 101. The object surface 101 is configured to emit the projection light beam to the redirecting mirror 110, and cause the projection light beam to be perpendicular to one of the right-angled faces incident to the redirecting mirror 110. The object surface 101 may be provided with a display chip to output the projection light beam. For example, the display chip may be a digital micromirror device (DMD) display chip, a liquid crystal on silicon (LCoS) display chip, or the like.

Optionally, in some other embodiments, the redirecting mirror 110 may be omitted. The object surface 101 is arranged on one side, distal from the aperture stop 130, of the first lens group 120, and is perpendicular to the central optical axis L1 of the first lens group 120. The object surface 101 directly emits the projection light beam to the first lens group 120.

The first lens group 120 may include a plurality of optical lenses. A length of the first lens group 120 is less than 12 mm, and a clear aperture of the first lens group 120 is less than 11.5 mm. The first lens group 120 has a greater positive focal power, and the first lens group 120 satisfies 6.0<(φ₁/φₛ)<8.0; wherein φₛ is the focal power of the telecentric projection lens 100, and φ₁ is the focal power of the first lens group 120, such that an object-side numerical aperture of the telecentric projection lens 100 is 1.7. The first lens group 120 is configured to receive the projection light beam output by the redirecting mirror 110, collimate and expand the projection light beam, and output the light beam to the aperture stop 130. Preferably, a primary light ray in a central view filed emitted from the redirecting mirror 110 is parallel to or coincident with the central optical axis L1 of the first lens group 120.

Specifically, the first lens group 120 includes a first lens 121, a second lens 122, and a third lens 123. The first lens 121, the second lens 122, and the third lens 123 are made of glass or plastic materials. The first lens 121, the second lens 122, and the third lens 123 are successively arranged along the central optical axis L1 of the first lens group 120 in a direction from the redirecting mirror 110 to the second lens group 140. A central optical axis of the first lens 121 and a central optical axis of the second lens 122 coincide with a central optical axis of the third lens 123, such that the projection light beam emitted from the redirecting mirror 110 successively passes through the first lens 121, the second lens 122, and the third lens 123 along the central optical axis L1 of the first lens group 120.

Optionally, a light emitting surface of the first lens 121 may be arranged to be seamlessly attached to a light incident surface of the second lens 122.

The first lens 121 is a convex lens and has a positive focal power, and the first lens 121 satisfies 0.3<((φ₁₁/φ₁)<0.8. The second lens 122 is a convex lens, and has a positive focal power. The focal power of the second lens 122 is less than the focal power of the first lens 121, and the second lens 122 satisfies 0.8<(φ₁₂/φ₁₁)<1.0. The third lens 123 may be a single lens or a double-cemented lens, and has a positive focal power or a negative focal power. For example, as illustrated in FIG. 1, the third lens 123 is the single lens, and has a negative focal power; and as illustrated in FIG. 2, the third lens 123 is the double-cemented lens, and has a negative focal power. The third lens 123 satisfies |φ₁₃/φ₁|<0.5; wherein φ₁ is the focal power of the first lens group 120, φ₁₁ is the focal power of the first lens 121, φ₁₂ is the focal power of the second lens 122, and φ₁₃ is the focal power of the third lens 123. In this way, a value of an object-side numerical aperture of the double telecentric projection lens 100 is ensured.

In this embodiment, as illustrated in FIG. 1, when the third lens 123 is a single lens, the first lens 121 is a lenticular lens, and the second lens 122 includes a convex surface facing the object surface and an adjacent next flat surface facing the image surface, and the third lens 123 includes a concave surface facing the object surface and an adjacent next flat surface facing the image surface.

Optionally, in some other embodiments, as illustrated in FIG. 2, when the third lens 123 is a double-cemented lens, the first lens 121 includes a flat surface facing the object surface and an adjacent next convex surface facing the image surface, the second lens 122 includes a convex surface facing the object surface and an adjacent next flat surface facing the image surface, one cemented lens of the third lens 123 includes a convex surface facing the object surface and an adjacent next convex surface facing the image surface, and the other cemented lens of the third lens 123 includes a concave surface facing the object surface and an adjacent next flat surface facing the image surface.

The aperture stop 130 is arranged between the first lens group 120 and the second lens group 140, and a central optical axis of the aperture stop 130 coincides with the central optical axis L1 of the first lens group 120, and a central optical axis L2 of the second lens group 140. In addition, the aperture stop 130 is at a rear focus of the first lens group 120 and a front focus of the second lens group 140 to form the double telecentric imaging light path, such that magnification of the double telecentric projection lens 100 is stable and does not vary with the change of the depth of field. The rear focus of the first lens group 120 is a focus of the first lens group 120 proximal to a side of the second lens group 140. The front focus of the second lens group 140 is a focus of the second lens group 140 proximal to a side of the first lens group 120. The aperture stop 130 is configured to receive the projection light beam emitted from the first lens group 120, and cause the projection light beam to be transmitted to the second lens group 140. The first lens group 120 and the second lens group 140 are made to be approximately symmetric about the aperture stop 130 to form a variable double-Gaussian structure, such that during prorogation of the projection light beam, lateral aberrations (for example, spherical aberrations, lateral chromatic aberrations, or the like) introduced by the first lens 120 and the second lens 140 are offset, such that the lateral aberrations of the double telecentric projection lens 100 are effectively reduced.

The second lens group 140 may include a plurality of optical lenses. A length of the second lens group 140 is less than 9 mm, and a clear aperture of the second lens group 140 is less than 7 mm. The second lens group 140 has a positive focal power, and the second lens group 140 satisfies 0.5<((φ₂/φₛ)<1.5; wherein φₛ is the focal power of the telecentric projection lens 100, and φ₂ is a focal power of the second lens group 140, such that an image-side numerical aperture of the telecentric projection lens 100 is 5.95. The second lens group 140 is configured to receive a projection light beam output by the aperture stop 130, and converge the projection light beam and cause the projection light beam to be transmitted parallel to the central optical axis L2 of the second lens group 140. Optionally, a primary light ray in a central view filed emitted from the aperture stop 130 is parallel to or coincident with the central optical axis L2 of the second lens group 140.

Specifically, the second lens group 140 includes a fourth lens 144, a fifth lens 145, and a sixth lens 146. The fourth lens 144, the fifth lens 145, and the six lens 146 are made of glass or plastic materials. The fourth lens 144, the fifth lens 145, and the sixth lens 146 are successively arranged along the central optical axis L2 of the second lens group 140 in a direction from the redirecting mirror 110 to the second lens group 140. A central optical axis of the fourth lens 144, and a central optical axis of the fifth lens 145 coincide with a central optical axis of the sixth lens 146, such that the projection light beam emitted from the aperture stop 130 successively passes through the fourth lens 144, the fifth lens 145, and the sixth lens 146 along the central optical axis L2 of the fourth lens group 140.

Optionally, a light emitting surface of the fifth lens 145 may be arranged to be seamlessly attached to a light incident surface of the sixth lens 146.

The fourth lens 144 is a concave lens and has a negative focal power, and the fourth lens 144 satisfies −10.0<(φ₂₄/φ₂)<−6.0. The fifth lens 145 is a meniscus shaped lens and has a positive focal power, and the fifth lens 145 satisfies 1.5<(φ₂₅/φ₂)<2.0. The sixth lens 146 is a convex lens, and has a positive focal power. The focal power of the sixth lens 146 is less than the focal power of the fifth lens 145, and the sixth lens satisfies 0.5<(φ₂₆/φ₂₅)<0.7. φ₂ is the focal power of the second lens group 140, φ₂₄ is the focal power of the fourth lens 144, φ₂₅ is the focal power of the fifth lens 145, and φ₂₆ is the focal power of the sixth lens 146. In this way, a value of an image-side numerical aperture of the double telecentric projection lens 100 is ensured.

In this embodiment, as illustrated in FIG. 1, when the third lens 123 is a single lens, the fourth lens 144 is a concave lens, and the fifth lens 145 includes a concave surface facing the object surface, and a next adjacent convex surface facing the image surface, and the sixth lens 146 includes a convex surface facing the object surface, and an adjacent next convex surface facing the image surface.

Optionally, in some other embodiments, as illustrated in FIG. 2, when the third lens 123 is a double-cemented lens, the fourth lens 144 includes a concave surface facing the object surface and an adjacent next concave surface facing the image surface, the fifth lens 145 includes a concave surface facing the object surface and an adjacent next convex surface facing the image surface, the sixth lens 146 includes a convex surface facing the object surface and an adjacent next flat surface facing the image surface, and the fifth lens 145 and the sixth lens 146 are arranged to be attached to each other.

Optionally, as illustrated in FIG. 1 or FIG. 2, the double telecentric projection lens 100 may achieve imaging on an image surface 102. The image surface 102 is configured to receive a projection light beam emitted from the second lens group 140, and achieve imaging. The image surface 102 may be perpendicular to the central optical axis L2 of the second lens group 140, such that the projection light beam transmitted by the second lens group 140 is converged on the image surface 102. In this way, the formed projection image has a good illumination uniformity.

Optionally, the double telecentric projection lens 100 may further include a redirecting structure (not illustrated). The redirecting structure may be a refraction structure or a reflection structure. The redirecting structure is arranged between the second lens group 140 and the image surface 102, and is configured to redirect the projection light beam emitted from the second lens group 140. In this way, a position of the image surface 102 may be flexibly defined.

In this embodiment, a focal length of the first lens group 120 is in proportion to a focal length of the second lens group 140, such that the double telecentric projection lens 100 has a magnification of 3.5. An object-side telecentricity of the double telecentric projection lens 100 is less than 0.8°, and an image-side telecentricity of the double telecentric projection lens 100 is less than 1.8°.

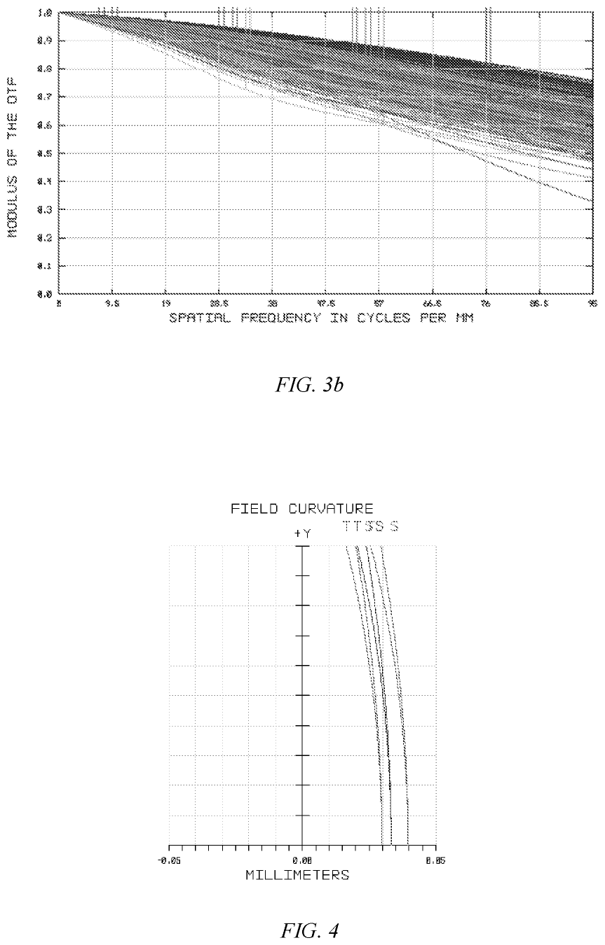

Referring to FIG. 3a, FIG. 3a is schematic diagram of a modulation transfer function (MTF) of the double telecentric projection lens at a spatial frequency of 1001 p/mm. As seen from FIG. 3a, a spatial frequency per millimeter cycle of the double telecentric projection lens 100 at the spatial frequency of 1001 p/m is greater than 60%. A tolerance analysis is performed for the double telecentric projection lens 100 by using the Monte Carlo method. Where an introduced tolerance is satisfied, as illustrated in FIG. 3b, the spatial frequency per millimeter cycle of the double telecentric projection lens 100 at the spatial frequency of 1001 p/m is greater than 30%.

Referring to FIG. 4, FIG. 4 is schematic diagram of a distortion curve of the double telecentric projection lens in FIG. 1. As seen from FIG. 4, variation of a distortion amount of the double telecentric projection lens 100 is extremely small, within 0.5%.

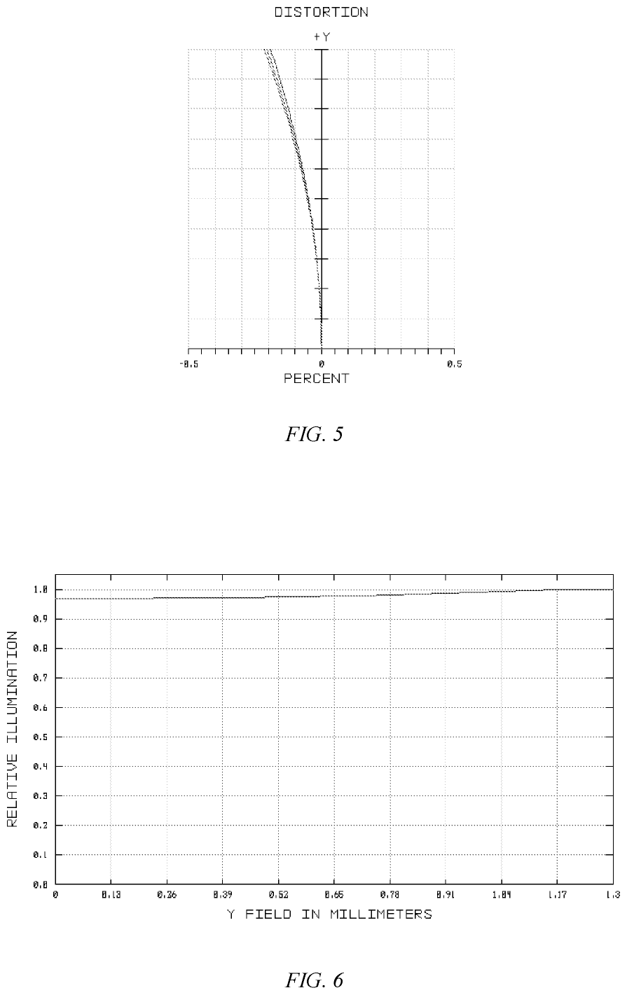

Referring to FIG. 5, FIG. 5 is schematic diagram of a curve of a field curvature of the double telecentric projection lens in FIG. 1. As seen from FIG. 5, the field curvature of the double telecentric projection lens 100 is less than 0.05 mm.

Referring to FIG. 6, FIG. 6 is schematic diagram of a curve of relative illumination of the double telecentric projection lens in FIG. 1. As seen from FIG. 6, the relative illumination of the double telecentric projection lens 100 is greater than 92%.

In this embodiment, the operating process of the double telecentric projection lens 100 is approximately as follows: An incident projection light beam is redirected by the redirecting mirror 110 and is incident to the first lens group 120 parallel to the central optical axis L1 of the first lens group 120, the first lens group 120 expands the projection light beam, the projection light beam passes through the aperture stop 130 and is incident to the second lens group 140, and the second lens group 140 converges the projection light beam and causes the projection light beam to be emitted parallel to the central optical axis L2 of the second lens group 140. In this way, imaging is achieved on the image surface 102.

In this embodiment, in the double telecentric projection lens 100, the first lens group 120 receives a projection light beam incident parallel to a central optical axis L1 of the first lens group 120, and expands the projection light beam; the aperture stop 130 receives the projection light beam emitted from the first lens group 120, and causes the projection light beam to be transmitted to the second lens group 140; and the second lens group 140 receives the projection light beam emitted from the aperture stop 130, converges the projection light beam, and causes the projection light beam to be emitted parallel to a central optical axis L2 of the second lens group 140. By placing the aperture stop to an image-side focal plane and an object-side focal plane, a primary light ray on the object side and a primary light ray on the image side are parallel to the optical axis, a double telecentric imaging light path is formed. In addition, the structure is simple, and illumination uniformity is good.

### Second Embodiment

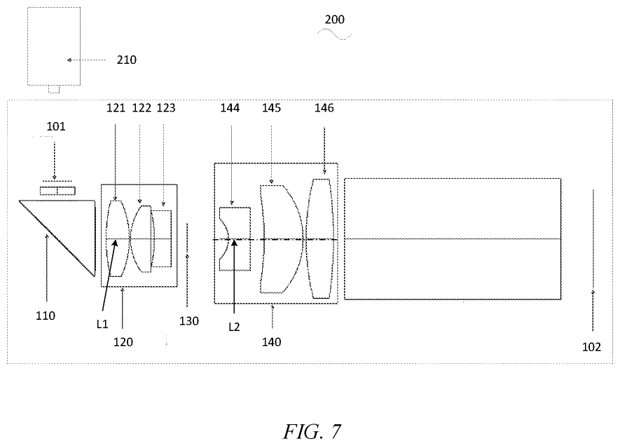

Referring to FIG. 7, FIG. 7 is a schematic structural diagram of a projection system 200 according to an embodiment of the present disclosure. As illustrated in FIG. 7, the projection system 200 includes the double telecentric projection lens 100 in the first embodiment.

Optionally, the projection system 200 further includes an illumination module 210. The illumination module 210 may be a laser light source, for example, an optical fiber coupling laser light source, a diode laser light source, or a solid laser light source, or the like. The illumination module 210 may include a red laser light source, a green laser light source, and a blue laser light source. By using the tri-primary color laser, the illumination module 210 is capable of causing the double telecentric projection lens 100 to most realistically reproduce abundant and wonderful colors of the real world and achieve a more shocking expression.

The illumination module 210 is arranged on a light incident side of the double telecentric projection lens 100, that is, the illumination module 210 is configured to supply an illumination light beam to the double telecentric projection lens 100. A position of the illumination module 210 relative to the double telecentric projection lens 100 may be determined by an incident direction of the illumination light beam.

In this embodiment, the projection system 200 is provided with the double telecentric projection lens 100 having a simple structure and achieving a good illumination uniformity, such that the entire projection system 200 has a simple structure and achieves a good illumination uniformity, and further has merits of fixed magnification, high telecentricity, great depth of field, and the like.

It should be noted that the specification and drawings of the present disclosure illustrate preferred embodiments of the present disclosure. However, the present disclosure may be implemented in different manners, and is not limited to the embodiments described in the specification. The embodiments described are not intended to limit the present disclosure, but are directed to rendering a thorough and comprehensive understanding of the disclosure of the present disclosure. In addition, the above described technical features may be incorporated and combined with each other to derive various embodiments not illustrated in the above specification, and such derived embodiments shall all be deemed as falling within the scope of the disclosure contained in the specification of the present disclosure. Further, a person skilled in the art may make improvements or variations according to the above description, and such improvements or variations shall all fall within the protection scope as defined by the claims of the present disclosure.

What is claimed is:

1. A double telecentric projection lens, comprising: a first lens group, an aperture stop, and a second lens group that are successively arranged from an object side to an image side, a center of the aperture stop being at a rear focus of the first lens group and a front focus of the second lens group; wherein
the first lens group is configured to receive a projection light beam incident parallel to a central optical axis of the first lens group, and expand the projection light beam;
the aperture stop is configured to receive the projection light beam emitted from the first lens group, and cause the projection light beam to be transmitted to the second lens group; and
the second lens group is configured to receive the projection light beam emitted from the aperture stop, converge the projection light beam, and cause the projection light beam to be emitted parallel to a central optical axis of the second lens group;
wherein a focal power of the double telecentric projection lens is greater than 0.03, an object-side numerical aperture of the double telecentric projection lens is 1.7, and an image-side numerical aperture of the double telecentric projection lens is 5.95.

2. The double telecentric projection lens according to claim 1, wherein
the first lens group satisfies 6.0<(φ₁/φₛ)<8.0; and
the second lens group satisfies 0.5<(φ₂/φₛ)<1.5;
wherein φₛ is the focal power of the double telecentric projection lens, φ₁ is a focal power of the first lens group, and φ₂ is a focal power of the second lens group.

3. The double telecentric projection lens according to claim 2, wherein the first lens group comprises a first lens, a second lens, and a third lens that are successively arranged along the central optical axis of the first lens group;
wherein the first lens has a positive focal power, the second lens has a positive focal power, and the third lens has a positive focal power or a negative focal power, the focal power of the second lens being less than the focal power of the first lens.

4. The double telecentric projection lens according to claim 3, wherein
the first lens satisfies 0.3<(φ₁₁/φ₁)<0.8;
the second lens satisfies 0.8<(φ₁₂/φ₁₁)<1.0; and
the third lens satisfies |φ₁₃/φ₁|<0.5;
wherein φ₁ is the focal power of the first lens group, φ₁₁ is a focal power of the first lens, φ₁₂ is a focal power of the second lens, and φ₁₃ is a focal power of the third lens.

5. The double telecentric projection lens according to claim 3, wherein the third lens is a single lens or a double-cemented lens.

6. The double telecentric projection lens according to claim 2, wherein the second lens group comprises a fourth lens, a fifth lens, and a sixth lens that are successively arranged along the central optical axis of the second lens group;
wherein the fourth lens has a negative focal power, the fifth lens is a meniscus shaped lens having a positive focal power, and the sixth lens has a positive focal power, the focal power of the sixth lens being less than the focal power of the fifth lens.

7. The double telecentric projection lens according to claim 6, wherein
the fourth lens satisfies −10.0<(φ₂₄/φ₂)<−6.0;
the fifth lens satisfies 1.5<(φ₂₅/φ₂)<2.0; and
the sixth lens satisfies 0.5<(φ₂₆/φ₂₅)<0.7;
wherein φ₂ is the focal power of the second lens group, φ₂₄ is a focal power of the fourth lens, φ₂₅ is a focal power of the fifth lens, and φ₂₆ is a focal power of the sixth lens.

8. The double telecentric projection lens according to claim 1, further comprising:
a redirecting mirror, arranged on one side, distal from the aperture stop, of the first lens group, and configured to redirect the projection light beam such that the projection light beam is incident to the first lens group.

9. The double telecentric projection lens according to claim 8, wherein the redirecting mirror is a total internal reflection prism.

10. A projection system, comprising an illumination module and a double telecentric projection lens, the illumination module is arranged on a light incident side of the double telecentric projection lens, the illumination module is configured to supply an illumination light beam to the double telecentric projection lens;
the double telecentric projection lens comprising: a first lens group, an aperture stop, and a second lens group that are successively arranged from an object side to an image side, a center of the aperture stop being at a rear focus of the first lens group and a front focus of the second lens group; wherein
the first lens group is configured to receive a projection light beam incident parallel to a central optical axis of the first lens group, and expand the projection light beam;
the aperture stop is configured to receive the projection light beam emitted from the first lens group, and cause the projection light beam to be transmitted to the second lens group; and
the second lens group is configured to receive the projection light beam emitted from the aperture stop, converge the projection light beam, and cause the projection light beam to be emitted parallel to a central optical axis of the second lens group;
wherein a focal power of the double telecentric projection lens is greater than 0.03, an object-side numerical aperture of the double telecentric projection lens is 1.7, and an image-side numerical aperture of the double telecentric projection lens is 5.95.

11. The projection system according to claim 10, wherein
the first lens group satisfies 6.0<(φ₁/φₛ)<8.0; and
the second lens group satisfies 0.5<(φ₂/φₛ)<1.5;
wherein φₛ is the focal power of the double telecentric projection lens, φ₁ is a focal power of the first lens group, and φ₂ is a focal power of the second lens group.

12. The projection system according to claim 11, wherein the first lens group comprises a first lens, a second lens, and a third lens that are successively arranged along the central optical axis of the first lens group;
wherein the first lens has a positive focal power, the second lens has a positive focal power, and the third lens has a positive focal power or a negative focal power, the focal power of the second lens being less than the focal power of the first lens.

13. The projection system according to claim 12, wherein
the first lens satisfies 0.3<(φ₁₁/φ₁)<0.8;
the second lens satisfies 0.8<(φ₁₂/φ₁₁)<1.0; and
the third lens satisfies |φ₁₃/φ₁|<0.5;
wherein φ₁ is the focal power of the first lens group, φ₁₁ is a focal power of the first lens, φ₁₂ is a focal power of the second lens, and φ₁₃ is a focal power of the third lens.

14. The projection system according to claim 12, wherein the third lens is a single lens or a double-cemented lens.

15. The projection system according to claim 11, wherein the second lens group comprises a fourth lens, a fifth lens, and a sixth lens that are successively arranged along the central optical axis of the second lens group;
wherein the fourth lens has a negative focal power, the fifth lens is a meniscus shaped lens having a positive focal power, and the sixth lens has a positive focal power, the focal power of the sixth lens being less than the focal power of the fifth lens.

16. The projection system according to claim 15, wherein
the fourth lens satisfies −10.0<(φ₂₄/(φ₂)<−6.0;
the fifth lens satisfies 1.5<(φ₂₅/φ₂)<2.0; and
the sixth lens satisfies 0.5<(φ₂₆/φ₂₅)<0.7;
wherein φ₂ is the focal power of the second lens group, φ₂₄ is a focal power of the fourth lens, φ₂₅ is a focal power of the fifth lens, and φ₂₆ is a focal power of the sixth lens.

17. The projection system according to claim 10, further comprising:
a redirecting mirror, arranged on one side, distal from the aperture stop, of the first lens group, and configured to redirect the projection light beam such that the projection light beam is incident to the first lens group.

18. The projection system according to claim 17, wherein the redirecting mirror is a total internal reflection prism.
